(19) United States
(12) Patent Application Publication
(10) Pub. No.: US 2011/0058668 A1
(43) Pub. Date: Mar. 10, 2011

(54) Secure group key management approach based upon N-dimensional hypersphere

(75) Inventors: Zhimin Yang, Guangdong Province (CN); Shaohua Tang, Guangdong Province (CN); Borong Lu, Guangdong Province (CN)

(73) Assignee: South China University of Technology, Guangdong Province (CN)

(21) Appl. No.: 12/744,480

(22) PCT Filed: Mar. 31, 2009
(86) PCT No.: PCT/CN09/71094

§ 371 Date: May 25, 2010

(30) Foreign Application Priority Data
Feb. 18, 2009 (CN) 200910037233.8

(51) Int. Cl. H04L 9/00

(52) U.S. Cl. 380/44

(57) ABSTRACT

This invention publishes a secure group key management approach based upon N-dimensional hypersphere. After initialization, the GC admits the new members and assigns identifiers to them when there are new members joining the group, and deletes the leaving members' private information when there are members leaving the group. If a lot of members join and other members leave the group at the same time, the GC deletes the leaving members' private information, admits the new members, assigns indemnifiers to the new members, and then chooses mapping parameters, mapping each member's and its private information to the points in a multi-dimensional space. The GC calculates the central point of the hypersphere, and publishes the central point, the mapping parameter and the identifiers of leaving members if there are members leave. The group members calculate the mapping points, and then calculate the group keys. The invention can effectively reduce user storage, user computation, and amount of update information while re-keying. The independence of the group keys can be kept.

### BACKGROUND OF THE INVENTION

The present invention relates to group key management of network security, more specifically a secure group key management approach based upon N-dimensional hypersphere.

With the rapid development of internet technology and the popularization of multicast, group-oriented applications, such as video conference, network games, and video on demand, etc., are playing more and more important role. How to protect the communication security of these applications is also becoming more and more significant. Generally speaking, a secure group communication system should not only provide data confidentiality, user authentication, and information integrity, but also own perfect scalability. It is shown that a secure, efficient, and robust group key management approach is essential to a secure group communication system.

The major methods in group key management include Group Key Management Protocol (GKMP), Secure Lock (SL), Group Diffie-Hellman (GDH) and its improvement, Logical Key Hierarchy (LKH) and its improvement: (suppose n is the number of members in the group).

The Group Key Management Protocol (GKMP) is a direct extension from unicast to multicast communication. The GC (Group Controller) establishes a secure connection with each user in the group. When the group key is updated, the KDC should encrypt and deliver the new group key to each user individually. Then GC should encrypt n times and deliver n messages.

The Secure Lock (SL) scheme takes advantages of Chinese Remainder Theorem (CRT) to construct a secure lock to combine all the re-keying messages into one while the group key is updated. However, CRT is a time-consuming operation, and the size of the combined message is very large, so the SL scheme is efficient only when the number of users in a group is small.

The Group Diffie-Hellman (GDH) and its improvements consume great amount of CPU time in the process of key agreement. For the NON-SERIAL GDH that has the smallest computation, the number of total messages is up to n(n−1). The GDH.2 achieves minimal number of total messages, but the computation is up to n(n+3)/2−1 modulus exponentiations.

The Logical Key Hierarchy (LKH) and its improvements adopt tree structure to organize keys. The group controller maintains a virtual tree, and the nodes in the tree are assigned keys. The key held by the root of the tree is the group key. The internal nodes of the tree hold key encryption keys. Every member is assigned the keys along the path from its leaf to the root. When a member joins or leaves the group, the computation and communication overhead of re-keying are all decreased to O(log n). But if there are a great deal of members join or leave the group, then the re-keying overhead will increase proportionally to the number of members changed.

### BRIEF SUMMARY OF THE INVENTION

The object of this invention is to overcome the disadvantages or shortcomings of existing technology. In mathematics, a N-dimensional hypersphere or N-sphere of radius R is defined as the set of points in (N+1)-dimensional Euclidean space which are at distance R from a central point. Based on this principle, a secure group key management approach is provided. The invention can reduce user storage, user computation, and the amount of update information while re-keying efficiently, and enhance the independence of the group keys.

The object of this invention is achieved by technical solution as follow: a secure group key management approach based upon N-dimensional hypersphere, which comprises the following stages:

(1). Initialization: The GC (Group Controller) selects its private information, sets group finite field GF(p) and hash function h(·,·) of two variables, and then lets the first member join the group, where GF(p) designates finite field where group computation processes.

(2). Adding Members: The GC assigns identifiers to the new joining members after they are admitted, in the meantime, each new joining member should transmit its private information to the GC via a secure channel. The GC selects a mapping parameter, and maps this parameter and each new member's private information to the points in a multi-dimensional space. If the hypersphere can not be determined by the points, the GC should select another mapping parameter and re-map. The GC calculates the central point of the hypersphere which is established by the points, and then publishes the central point and the mapping parameter. Each member in the group calculates the mapping point by using its identifier, the central point and the mapping parameter, and then calculates its own group key.

(3). Removing Members: The GC deletes the leaving members' private information, selects new mapping parameters, and then maps parameters and each new member's private information into the points in the hypersphere. If the hypersphere can not be determined by the points, the GC should select another mapping parameter and re-map. The GC publishes the central points, the mapping parameters and the identifiers of the leaving members. The remnant members are sorted by identifiers and re-assigned new identifiers as 1, 2, 3, 4 . . . n. Each remnant user in the group calculates the mapping point by using its new identifier, the central point and the mapping parameter, and then calculates its own group key.

(4). Massive adding and removing: The GC deletes the leaving members' private information, assigns identifiers to the new joining members after they are admitted, in the meantime, each new joining member should transmit its private information to the GC via a secure channel. The GC selects mapping parameters, and then maps this parameters and each new member's private information into the points in the hypersphere. If the hypersphere can not be determined by the points, the GC should select another mapping parameter and re-map. The GC calculates the central point of the hypersphere which is established by the points, and then publishes the central point, the mapping parameter and the identifiers of the leaving members. The remnant members are sorted by identifiers and re-assigned new identifiers as 1, 2, 3, 4 . . . n. Each remnant user in the group calculates the mapping point by using its new identifier, the central point and the mapping parameter, and then calculates its own group key.

To better achieve this invention, the above stage (1) of initialization includes the following concrete steps:

(1.1). The GC selects two different two-dimensional points A₋₁(a_{-1,0},a_{-1,1}),A₀(a_{0,0},a_{0,1}) and keeps them secret. A large prime number p and a secure hash function h(·,·) are chosen and made public by the GC, where p designates the finite field GF(p) over which all the group computations are conducted, and a_{-1,0},a_{-1,1},a_{0,0},a_{0,1} are the integers over GF(p).

(1.2). Let the first member U₁ join the group. In general, U₁ is the group initiator:

a). After authenticating U₁, the GC assigns identifier ID=1 to U₁. In the meantime, U₁ should choose a two-dimensional point A₁(a₁₀,a₁₁), and then transmits A₁ to GC via a secure channel, where a_{0,0},a_{0,1} are the integers over GF (p), satisfying a₁₀≠a₁₁,a₁₀≠0, and a₁₁≠0.

b). The GC stores the point A₁(a₁₀,a₁₁), then selects a mapping parameter u₀ and maps GC's private information and U₁'s private information to the points in a multi-dimensional space:

For j=0, 1, 2, computes Bⱼ(bⱼ₀,bⱼ₁)=(h(a_{j-1,0},u₀),h(a_{j-1,1},u₀)),

If 2(b₀₀−b₁₀)·2(b₁₁−b₂₁)−2(b₁₀−b₂₀)·2(b₀₁−b₁₁)=0, re-selects another mapping parameter u₀ and re-calculates the points Bⱼ, where u₀ is a random integer, a_{j-1,0} and a_{j-1,1} are the components of private information, Aⱼ₋₁, bⱼ₀ and bⱼ₁ are the results of hash function h(·,·) applying to a_{j-1,0}, and a_{j-1,1} respectively.

c). The GC constructs the following system of equations to calculate the central point C₀(c₀₀,c₀₁) of the hypersphere:

$$\begin{matrix}{( {b}_{00} - {c}_{00} )}^{2} + {( {b}_{01} - {c}_{01} )}^{2} = {R}_{0}^{2} \\ {( {b}_{10} - {c}_{00} )}^{2} + {( {b}_{11} - {c}_{01} )}^{2} = {R}_{0}^{2} \\ {( {b}_{20} - {c}_{00} )}^{2} + {( {b}_{21} - {c}_{01} )}^{2} = {R}_{0}^{2}\end{matrix} \}$$

By subtracting the first equation from the second one, and subtracting the second equation from the third one, we can get a system of linear equations:

$$\begin{matrix}2 ( {b}_{00} - {b}_{10} ) {c}_{00} + 2 ( {b}_{01} - {b}_{11} ) {c}_{01} = {b}_{00}^{2} + {b}_{01}^{2} - {b}_{10}^{2} - {b}_{11}^{2} \\ 2 ( {b}_{10} - {b}_{20} ) {c}_{00} + 2 ( {b}_{11} - {b}_{21} ) {c}_{01} = {b}_{10}^{2} + {b}_{11}^{2} - {b}_{20}^{2} - {b}_{21}^{2}\end{matrix} \}$$

The condition 2(b₀₀−b₁₀)·2(b₁₁−b₂₁)−2(b₁₀−b₂₀)·2(b₀₁−b₁₁)≠0 in b) guarantees that the above system of equations has one and only one solution.

d). The GC delivers the central points C₀(c₀,c₁) and the mapping parameter u₀ to the member U₁ via open channel.

e). The member U₁ calculates its group key:

K₁=R₀²−∥C₀∥²=h(a₁₀,u₀)²+h(a₁₁,u₀)²−2h(a₁₀,u₀)c₀₀−2h(a₁₁,u₀)c₀₁

where R₀ is the radius of the circle whose central point is C₀, ∥C₀∥²=c₀₀²+c₀₁², and K₁ is the group key that is computed by the member U₁.

The above stage (2) of adding members includes the following concrete steps:

(2.1). Suppose there are n−δ members in the group, where n−δ≧1 and δ≧1, and there are δ new members want to join the group. After the new members are admitted, there should be n members in the group, and every new member is assigned new identifier as (n−δ)+1, (n−δ)+2, . . . , (n−δ)+δ. For x=(n−δ)+1, (n−δ)+2, . . . , (n−δ)+δ, each new member Uₓ selects its private two-dimensional point Aₓ(aₓ₀,aₓ₁) where aₓ₀≠aₓ₁,aₓ₀≠0,aₓ₁≠0, and transmits the point Aₓ to the GC via a secure channel. The GC stores Aₓ(aₓ₀,aₓ₁) securely.

(2.2). The GC selects a mapping parameter u₁, and maps its and each member's private information to the points in a multi-dimensional space:

The GC Computes Bᵢ(bᵢ₀,bᵢ₁)=(h(aᵢ₀,u₁),h(aᵢ₁,u₁)) by utilizing the two dimensional point Aᵢ(aᵢ₀,aᵢ₁) that the GC stores, where Aᵢ(aᵢ₀,aᵢ₁) is a 2-dimensional point in the group, Bᵢ(bᵢ₀,bᵢ₁) is the result of hash function applying to the values of 2-dimensional in Aᵢ(aᵢ₀,aᵢ₁), bᵢ₀ and bᵢ₁ are the results of hash function applying to aᵢ₀ and aᵢ₁ respectively, i is the subscript of member's private information. The GC re-assigns the subscripts of Bᵢ according to the values of original subscripts, and let the subscripts begin from 0. Then the new set of points Bᵢ is now {Bᵣ|r=0, 1, . . . , n+1}.

If

$$[ \begin{matrix}2 ( {b}_{00} - {b}_{10} ) \cdot 2 ( {b}_{11} - {b}_{21} ) - \\ 2 ( {b}_{10} - {b}_{20} ) \cdot 2 ( {b}_{01} - {b}_{11} )\end{matrix} ] \cdot {\prod }_{t = 3}^{n + 1} ( - 2 {b}_{t 1} ) = 0 ,$$

GC repeats step (2.2).

(2.3). The GC computes C₁(c₁₀, c₁₁, c₁₂, . . . , c₁ₙ), the central point of the hypersphere that established by Bᵣ:

Expanding Bᵣ: The GC expends Bᵣ to become a (n+1)-dimensional point Vᵣ. For r=0,1, Bᵣ is supplemented n−1 zeros to become Vᵣ(bᵣ₀, bᵣ₁, 0 . . . 0). For r=2, 3, . . . , n+1, let Vᵣ=(bᵣ₀, 0, . . . , 0, bᵣ₁, 0 . . . 0), where the number of zero between bᵣ₀ and bᵣ₁ is r−2, and there are n+1−r zeros supplemented after bᵣ₁.

The GC constructs the system of equations:

$$\begin{matrix}{( {b}_{00} - {c}_{10} )}^{2} + {( {b}_{01} - {c}_{11} )}^{2} + {( 0 - {c}_{12} )}^{2} + {( 0 - {c}_{13} )}^{2} … + {( 0 - {c}_{1 n} )}^{2} = {R}_{1}^{2} \\ {( {b}_{10} - {c}_{10} )}^{2} + {( {b}_{11} - {c}_{11} )}^{2} + {( 0 - {c}_{12} )}^{2} + {( 0 - {c}_{13} )}^{2} … + {( 0 - {c}_{1 n} )}^{2} = {R}_{1}^{2} \\ {( {b}_{20} - {c}_{10} )}^{2} + {( {b}_{21} - {c}_{11} )}^{2} + {( 0 - {c}_{12} )}^{2} + {( 0 - {c}_{13} )}^{2} … + {( 0 - {c}_{1 n} )}^{2} = {R}_{1}^{2} \\ {( {b}_{30} - {c}_{10} )}^{2} + {( 0 - {c}_{11} )}^{2} + {( {b}_{31} - {c}_{12} )}^{2} + {( 0 - {c}_{13} )}^{2} … + {( 0 - {c}_{1 n} )}^{2} = {R}_{1}^{2} \\ {( {b}_{40} - {c}_{10} )}^{2} + {( 0 - {c}_{11} )}^{2} + {( 0 - {c}_{12} )}^{2} + {( {b}_{41} - {c}_{13} )}^{2} … + {( 0 - {c}_{1 n} )}^{2} = {R}_{1}^{2} \\ … \\ {( {b}_{n + 1 , 0} - {c}_{10} )}^{2} + {( 0 - {c}_{11} )}^{2} + {( 0 - {c}_{12} )}^{2} + {( 0 - {c}_{13} )}^{2} … + ( {b}_{n + 1 , 1} - {c}_{1 n} ) = {R}_{1}^{2}\end{matrix} \}$$

Subtracts the j-th equation from the (j+1)-th equation:

$$[ \begin{matrix}2 ( {b}_{00} - {b}_{10} ) & 2 ( {b}_{01} - {b}_{11} ) & 0 & … & … & 0 \\ 2 ( {b}_{10} - {b}_{20} ) & 2 ( {b}_{11} - {b}_{21} ) & 0 & … & … & 0 \\ 2 ( {b}_{20} - {b}_{30} ) & 2 {b}_{21} & - 2 {b}_{31} & 0 & … & 0 \\ 2 ( {b}_{30} - {b}_{40} ) & 0 & 2 {b}_{31} & - 2 {b}_{41} & 0 … & 0 \\ & & … & & & \\ 2 ( {b}_{n 0} - {b}_{n + 1 , 0} ) & 0 & … & 0 & 2 {b}_{n 1} & - 2 {b}_{n + 1 , 1}\end{matrix} ] [ \begin{matrix}{c}_{10} \\ {c}_{11} \\ {c}_{12} \\ {c}_{13} \\ … \\ {c}_{1 n}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2} \\ … \\ {b}_{n 0}^{2} + {b}_{n 1}^{2} - {b}_{n + 1 , 0}^{2} - {b}_{n + 1 , 1}^{2}\end{matrix} ]$$

The condition

$$[ \begin{matrix}2 ( {b}_{00} - {b}_{10} ) \cdot 2 ( {b}_{11} - {b}_{21} ) - \\ 2 ( {b}_{10} - {b}_{20} ) \cdot 2 ( {b}_{01} - {b}_{11} )\end{matrix} ] \cdot {\prod }_{t = 3}^{n + 1} ( - 2 {b}_{t 1} ) \neq 0$$

in (2.2) guarantees that the above system of equations has one and only one solution.

(2.4). The GC multicasts the central point C₁(c₁₀, c₁₁, c₁₂, . . . , c₁ₙ) and the mapping parameter u₁ to all the group members via open channel.

(2.5). Each group member calculates the group key by using its private point Aᵢ(aᵢ₀,aᵢ₁) and the public information C₁(c₁₀, c₁₁, c₁₂, . . . , c₁ₙ), u₁:

Kᵢ=R₁²−∥C₁∥²=h(aᵢ₀,u₁)²+h(aᵢ₁,u₁)²−2h(aᵢ₀,u₁)c₁₀−2h(aᵢ₁,u₁)c_{1d}, where Kᵢ is the group key calculated by the user whose private information's subscript is i, aᵢ₀,aᵢ₁ are the components of private information Aᵢ, d is the user's identifier, R₁ is the radius of the hypersphere, and

$$\vert \vert {C}_{1} {\vert \vert}^{2} = {\sum }_{m = 0}^{n} {c}_{1 m}^{2} .$$

The above stage (3) of removing members includes the following concrete steps:

(3.1). Suppose there are n+f members in the group, and there are f members want to leave the group, where n+f≧2 and f≧1. After f members leave, there should be n members in the group. The GC deletes the leaving members' private two-dimensional points.

(3.2). The GC selects a mapping parameter u₂, maps its and the remnant member's private information to the points in a multi-dimensional space:

The GC Computes Bᵢ(bᵢ₀,bᵢ₁)=(h(aᵢ₀,u₂),h(aᵢ₁,u₂)) by utilizing the two dimensional point Aᵢ(aᵢ₀,aᵢ₁) that the GC stores. The GC re-assigns the subscripts of Bᵢ according to the values of original subscripts, and let the subscripts begin from 0. Then the new set of points Bᵢ is now {Bᵣ|r=0, 1, . . . , n+1}.

If

$$[ \begin{matrix}2 ( {b}_{00} - {b}_{10} ) \cdot 2 ( {b}_{11} - {b}_{21} ) - \\ 2 ( {b}_{10} - {b}_{20} ) \cdot 2 ( {b}_{01} - {b}_{11} )\end{matrix} ] \cdot {\prod }_{t = 3}^{n + 1} ( - 2 {b}_{t 1} ) = 0 ,$$

repeat step (3.2).

(3.3). The GC computes C₂(c₂₀, c₂₁, c₂₂, . . . , c₂ₙ), the central point of the hypersphere that established by Bᵣ:

Expanding Bᵣ: The GC expends Bᵣ to become a (n+1)-dimensional point Vᵣ. For r=0,1, Bᵣ is supplemented n−1 zeros to become Vᵣ(bᵣ₀, bᵣ₁, 0 . . . 0). For r=2, 3, . . . , n+1, let Vᵣ=(bᵣ₀, 0, . . . , 0, bᵣ₁, 0 . . . 0), where the number of zero between bᵣ₀ and bᵣ₁ is r−2, and there are n+1−r zeros supplemented after bᵣ₁.

The GC constructs the system of equations:

$$\begin{matrix}{( {b}_{00} - {c}_{20} )}^{2} + {( {b}_{01} - {c}_{21} )}^{2} + {( 0 - {c}_{22} )}^{2} + {( 0 - {c}_{23} )}^{2} … + {( 0 - {c}_{2 n} )}^{2} = {R}_{2}^{2} \\ {( {b}_{10} - {c}_{20} )}^{2} + {( {b}_{11} - {c}_{21} )}^{2} + {( 0 - {c}_{22} )}^{2} + {( 0 - {c}_{23} )}^{2} … + {( 0 - {c}_{2 n} )}^{2} = {R}_{2}^{2} \\ {( {b}_{20} - {c}_{20} )}^{2} + {( {b}_{21} - {c}_{21} )}^{2} + {( 0 - {c}_{22} )}^{2} + {( 0 - {c}_{23} )}^{2} … + {( 0 - {c}_{2 n} )}^{2} = {R}_{2}^{2} \\ {( {b}_{30} - {c}_{20} )}^{2} + {( 0 - {c}_{21} )}^{2} + {( {b}_{31} - {c}_{22} )}^{2} + {( 0 - {c}_{23} )}^{2} … + {( 0 - {c}_{2 n} )}^{2} = {R}_{2}^{2} \\ {( {b}_{40} - {c}_{20} )}^{2} + {( 0 - {c}_{21} )}^{2} + {( 0 - {c}_{22} )}^{2} + {( {b}_{41} - {c}_{23} )}^{2} … + {( 0 - {c}_{2 n} )}^{2} = {R}_{2}^{2} \\ … \\ {( {b}_{n + 1 , 0} - {c}_{20} )}^{2} + {( 0 - {c}_{21} )}^{2} + {( 0 - {c}_{22} )}^{2} + {( 0 - {c}_{23} )}^{2} … + ( {b}_{n + 1 , 1} - {c}_{2 n} ) = {R}_{2}^{2}\end{matrix} \}$$

Subtracts the j-th equation from the (j+1)-th equation:

$$[ \begin{matrix}2 ( {b}_{00} - {b}_{10} ) & 2 ( {b}_{01} - {b}_{11} ) & 0 & … & … & 0 \\ 2 ( {b}_{10} - {b}_{20} ) & 2 ( {b}_{11} - {b}_{21} ) & 0 & … & … & 0 \\ 2 ( {b}_{20} - {b}_{30} ) & 2 {b}_{21} & - 2 {b}_{31} & 0 & … & 0 \\ 2 ( {b}_{30} - {b}_{40} ) & 0 & 2 {b}_{31} & - 2 {b}_{41} & 0 … & 0 \\ & & … & & & \\ 2 ( {b}_{n 0} - {b}_{n + 1 , 0} ) & 0 & … & 0 & 2 {b}_{n 1} & - 2 {b}_{n + 1 , 1}\end{matrix} ] [ \begin{matrix}{c}_{20} \\ {c}_{21} \\ {c}_{22} \\ {c}_{23} \\ … \\ {c}_{2 n}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2} \\ … \\ {b}_{n 0}^{2} + {b}_{n 1}^{2} - {b}_{n + 1 , 0}^{2} - {b}_{n + 1 , 1}^{2}\end{matrix} ]$$

The condition

$$[ \begin{matrix}2 ( {b}_{00} - {b}_{10} ) \cdot 2 ( {b}_{11} - {b}_{21} ) - \\ 2 ( {b}_{10} - {b}_{20} ) \cdot 2 ( {b}_{01} - {b}_{11} )\end{matrix} ] \cdot {\prod }_{t = 3}^{n + 1} ( - 2 {b}_{t 1} ) \neq 0$$

in (3.2) guarantees that the above system of equations has one and only one solution.

(3.4). The GC multicasts C₂, u₂ and all the identifiers of the leaving members to all the group members via open channel.

(3.5). The remnant members calculate their group keys:

Each remnant member compares its identifier with the identifiers of leaving members and computes the number of leaving members whose identifies less than its, and denoted by e. Then each remnant members adjusts its identifier as ID=ID−e, where the value of e calculated by each member may not be the same, and e≧0 and e≦f. Each remnant member calculates the group key:

K₁=R₂²−∥C₂∥²=h(aᵢ₀,u₂)²+h(aᵢ₁,u₂)²−2h(aᵢ₀,u₂)c₂₀−2h(aᵢ₁,u₂)c_{2d}, where Kᵢ is the group key calculated by the user whose secret's subscript is i, aᵢ₀,aᵢ₁ are the components of private information Aᵢ, d is the user's identifier, R₂ is the radius of the hypersphere, and

$${‖ {C}_{2} ‖}^{2} = {\sum }_{m = 0}^{n} {c}_{2 m}^{2} .$$

The above stage (4) of adding and removing members simultaneously includes the following concrete steps:

(4.1). Suppose there are n+w−v members in the group, where 1≦w≦(n+w−v) and 1≦v. There are w members want to leave, and v new members want to join the group simultaneously. After the membership changes, there should be n members in the group.

The GC deletes the leaving members' private two-dimensional points. For y=(n−v)+1, (n−v)+2, . . . , n, the value of y is assigned as the identifier of the new joining members. Each new member U_{y} selects its own private two-dimensional point A_{y}(a_{y0},a_{y1}), where a_{y0}≠a_{y1},a_{y0}≠0,a_{y1}≠0. The user U_{y} transmits the point A_{y}(a_{y0},a_{y1}) to the GC via a secure channel. After the member U_{y} is authenticated, the GC stores A_{y}(a_{y0},a_{y1}).

(4.2). The GC selects a mapping parameter u₃, and maps its and the each member's private information to the points in a multi-dimensional space:

The GC computes Bᵢ(bᵢ₀,bᵢ₁)=(h(aᵢ₀,u₃),h(aᵢ₁,u₃)) by utilizing the two dimensional point Aᵢ(aᵢ₀,aᵢ₁) that the GC stores. The GC re-assigns the subscripts of Bᵢ according to the values of original subscripts, and let the subscripts begin from 0. Then the new set of points Bᵢ is now {Bᵣ|r=0, 1, . . . , n+1}.

If

$$[ \begin{matrix}2 ( {b}_{00} - {b}_{10} ) \cdot 2 ( {b}_{11} - {b}_{21} ) - \\ 2 ( {b}_{10} - {b}_{20} ) \cdot 2 ( {b}_{01} - {b}_{11} )\end{matrix} ] \cdot {\prod }_{t = 3}^{n + 1} ( - 2 {b}_{t 1} ) = 0 ,$$

the GC repeats (4.2).

(4.3). The computes C₃(c₃₀, c₃₁, c₃₂, . . . , c₃ₙ), the central point of the hypersphere that established by Bᵣ:

Expanding Bᵣ: The GC expends Bᵣ to become a (n+1)-dimensional point Vᵣ. For r=0,1, Bᵣ is supplemented n−1 zeros to become Vᵣ(bᵣ₀, bᵣ₁, 0 . . . 0). For r=2, 3, . . . , n+1, lets Vᵣ=(bᵣ₀, 0, . . . , 0, bᵣ₁, 0 . . . 0), where the number of zero between bᵣ₀ and bᵣ₁ is r−2, and there are n+1−r zeros supplemented after bᵣ₁.

The GC constructs the system of equations:

$$\begin{matrix}{( {b}_{00} - {c}_{30} )}^{2} + {( {b}_{01} - {c}_{31} )}^{2} + {( 0 - {c}_{32} )}^{2} + {( 0 - {c}_{33} )}^{2} … + {( 0 - {c}_{3 n} )}^{2} = {R}_{3}^{2} \\ {( {b}_{10} - {c}_{30} )}^{2} + {( {b}_{11} - {c}_{31} )}^{2} + {( 0 - {c}_{32} )}^{2} + {( 0 - {c}_{33} )}^{2} … + {( 0 - {c}_{3 n} )}^{2} = {R}_{3}^{2} \\ {( {b}_{20} - {c}_{30} )}^{2} + {( {b}_{21} - {c}_{31} )}^{2} + {( 0 - {c}_{32} )}^{2} + {( 0 - {c}_{33} )}^{2} … + {( 0 - {c}_{3 n} )}^{2} = {R}_{3}^{2} \\ {( {b}_{30} - {c}_{30} )}^{2} + {( 0 - {c}_{31} )}^{2} + {( {b}_{31} - {c}_{32} )}^{2} + {( 0 - {c}_{33} )}^{2} … + {( 0 - {c}_{3 n} )}^{2} = {R}_{3}^{2} \\ {( {b}_{40} - {c}_{30} )}^{2} + {( 0 - {c}_{31} )}^{2} + {( 0 - {c}_{32} )}^{2} + {( {b}_{41} - {c}_{33} )}^{2} … + {( 0 - {c}_{3 n} )}^{2} = {R}_{3}^{2} \\ … \\ {( {b}_{n + 1 , 0} - {c}_{30} )}^{2} + {( 0 - {c}_{31} )}^{2} + {( 0 - {c}_{32} )}^{2} + {( 0 - {c}_{33} )}^{2} … + {( {b}_{n + 1 , 1} - {c}_{3 n} )}^{2} = {R}_{3}^{2}\end{matrix} \}$$

Subtracts the j-th equation from the (j+1)-th equation:

$$[ \begin{matrix}2 ( {b}_{00} - {b}_{10} ) & 2 ( {b}_{01} - {b}_{11} ) & 0 & … & … & 0 \\ 2 ( {b}_{10} - {b}_{20} ) & 2 ( {b}_{11} - {b}_{21} ) & 0 & … & … & 0 \\ 2 ( {b}_{20} - {b}_{30} ) & 2 {b}_{21} & - 2 {b}_{31} & 0 & … & 0 \\ 2 ( {b}_{30} - {b}_{40} ) & 0 & 2 {b}_{31} & - 2 {b}_{41} & 0 … & 0 \\ & & … & & & \\ 2 ( {b}_{n 0} - {b}_{n + 1 , 0} ) & 0 & … & 0 & 2 {b}_{n 1} & - 2 {b}_{n + 1 , 1}\end{matrix} ] [ \begin{matrix}{c}_{30} \\ {c}_{31} \\ {c}_{32} \\ {c}_{33} \\ … \\ {c}_{3 n}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2} \\ … \\ {b}_{n 0}^{2} + {b}_{n 1}^{2} - {b}_{n + 1 , 0}^{2} - {b}_{n + 1 , 1}^{2}\end{matrix} ]$$

The condition

$$[ \begin{matrix}2 ( {b}_{00} - {b}_{10} ) \cdot 2 ( {b}_{11} - {b}_{21} ) - \\ 2 ( {b}_{10} - {b}_{20} ) \cdot 2 ( {b}_{01} - {b}_{11} )\end{matrix} ] \cdot {\prod }_{t = 3}^{n + 1} ( - 2 {b}_{t 1} ) \neq 0$$

in (4.2) guarantees that the above system of equations has one and only one solution.

(4.4). The GC multicasts C₃, u₃ and all the identifiers of the leaving members to all the group members via open channel.

(4.5). The remnant members calculate their group keys:

Each remnant member compares its identifier with the identifiers of leaving members and computes the number of leaving members whose identifies less than its, and denoted by e. Then each remnant members adjusts its identifier as ID=ID−e, where the value of e calculated by each member may not be the same, and e≧0 and e≦w. Each remnant member calculates the group key:

Kᵢ=R₃²−∥C₃∥²=h(aᵢ₀,u₃)²+h(aᵢ₁,u₃)²−2h(aᵢ₀,u₃)c₁₀−2h(aᵢ₁,u₃)c_{3d}, where Kᵢ is the group key calculated by the user whose subscript is i, aᵢ₀,aᵢ₁ are the components of private information Aᵢ, d is the user's identifier, R₃ is the radius of the hypersphere, and

$${‖ {C}_{3} ‖}^{2} = {\sum }_{m = 0}^{n} {c}_{3 m}^{2} .$$

If there is not member adding or removing operation happened, and the group key is not updated within a period of time, then the GC will start periodically update procedure to renew the group key to safeguard the secrecy of group communication. The GC should select another mapping parameter and re-map when the hypersphere can not be determined by the points. The GC calculates the central point of the hypersphere which is established by the points, and then publishes the central point and the mapping parameter. Each user in the group calculates the mapping point by using its identifier, the central point and the mapping parameter, and then calculates its own group key.

The principle of this invention is: In mathematics, a N-dimensional hypersphere or N-sphere of radius R is defined as the set of points in (N+1)-dimensional Euclidean space which are at distance R from a central point. Based on this principle, a secure group key management approach is provided. In multi-dimensional space, a N-dimensional hypersphere equation can be can be represented as:

(g₀−c₀)²+(g₁−c₁)²+ . . . +(g_{N-1}−c_{N-1})²=R², (1)

where C(c₀, c₁, . . . , cₙ₋₁) is the central point, and R is the radius. Any given N+1 points Qₛ(qₛ₀, qₛ₁, . . . , s_{s,N-1}) in N-dimensional space, where s=0, 1, . . . , N, can uniquely determine a hypersphere as soon as certain condition is satisfied, which will be presented at the end of this subsection. The computation procedure is described as follows. By applying the coordinates of the points Q₀, Q₁, . . . , Q_{N} to Eqn(1), we can obtain a system of N+1 equations:

$$\begin{matrix}{( {q}_{00} - {c}_{0} )}^{2} + {( {q}_{01} - {c}_{1} )}^{2} + … + {( {q}_{0 , N - 1} - {C}_{N - 1} )}^{2} = {R}^{2} \\ {( {q}_{10} - {c}_{0} )}^{2} + {( {q}_{11} - {c}_{1} )}^{2} + … + {( {q}_{1 , N - 1} - {C}_{N - 1} )}^{2} = {R}^{2} \\ … \\ {( {q}_{N 0} - {c}_{0} )}^{2} + {( {q}_{N 1} - {c}_{1} )}^{2} + … + {( {q}_{N , N - 1} - {C}_{N - 1} )}^{2} = {R}^{2}\end{matrix} \} \qquad ( 2 )$$

By subtracting the j-th equation from the (j+1)-th equation, where j=1, 2, . . . , N, a system of linear equations with N unknowns c₀, c₁, . . . , c_{N-1} can be got:

$$\begin{matrix}2 ( {q}_{00} - {q}_{10} ) {c}_{0} + … + 2 ( {q}_{0 , N - 1} - {q}_{1 , N - 1} ) {c}_{N - 1} = {\sum }_{l = 0}^{N - 1} {q}_{0 l}^{2} - {\sum }_{l = 0}^{N - 1} {q}_{1 l}^{2} \\ … \\ 2 ( {q}_{N - 2 , 0} - {q}_{N - 1 , 0} ) {c}_{0} + … + 2 ( {q}_{N - 2 , N - 1} - {q}_{N - 1 , N - 1} ) {c}_{N - 1} = {\sum }_{l = 0}^{N - 1} {q}_{N - 2 , l}^{2} - {\sum }_{l = 0}^{N - 1} {q}_{N - 1 , l}^{2}\end{matrix} \} \qquad ( 3 )$$

If and if only the determinant of the coefficients in Eqn(3) is not equal to zero, this system of linear equations has unique solution c₀, c₁, . . . , c_{N}, and the distance between Qₛ and C(c₀,c₁, . . . , c_{N-1}) is R, where s=0, 1, . . . , N−1.

Compared with the existing technology, this invention has advantages and benefit effects as follow:

(1). The storage and computation of each member are small: The storage for each member is two private integers, and the computation includes two hash function operations and several operations in finite field when re-keying. Though the storage of GC is O(n) and the main computation of re-keying is O(n). In the same security assurance, consumption ca be decreased by reducing the size of the finite field and increasing the number of user's secret information. Suppose there are n members, if a member stores two integers and p is 64 bits, the communication in one re-keying will be 64(n+1) bits, but if P is 32 bits and four integers are stored, the communication will be about 32(n+3) bits.

(2). Number of re-keying message is just one, which can reduce consumption a lot when the GC needs to digitally sign on the message. The re-keying message includes the central point of the hypersphere, the mapping parameter and the leaving member's identifiers when re-keying caused by member leaving.

(3). When there is a lot of users join and leave simultaneously, consumption of re-keying will not increase with the growth of group members. Due to a lot of users join and leave simultaneously only needs one processing, the scheme has good capability in batch processing.

(4). The Group keys that the member calculates each time are independent, because the parameter in computation is Bᵢ(bᵢ₀,bᵢ₁) which is affected by hash function, where Bᵢ(bᵢ₀,bᵢ₁) is the result of hash function by applying to the values of 2-dimensional in Aᵢ(aᵢ₀,aᵢ₁). According to the properties of hash function, the central point and the square of the radius that the GC calculates each time are different and independent, even though the group key was exposed at one time, the security of group keys at another time will not be affected. The exposure of the group key will not cause member's secret leakage which is especially important to the high-confidential system.

(5). Prevent offline guess attack, collusion attack and exhausting attack effectively: 1, Bᵢ(bᵢ₀,bᵢ₁) cannot be derived from the central points and radius of the hyper-sphere. This can prevent the explosion of some regulations when the member's secret is invoked in multiple computations, and offline guess attack can then be prevented. 2, Even though a lot of group members colluded, it was unable to derive the two private information of the GC, so the collusion attack can be prevented. 3, User's private information is consist of two integers, suppose the length of prime number p is 64 bits, all the computations in our scheme are in the finite field GF(p), then the size of the exhausting space will be 2⁶⁴×2⁶⁴. Even the fastest computer in the world could conduct 10¹⁵ verifications per second, it still needed about 1.08*10¹⁶ years to find a valid group key in GF(p). Therefore, the exhausting attack can be prevented effectively.

### BRIEF DESCRIPTION OF THE DRAWINGS

FIG. 1 is the secure group communication system architecture schematic diagram in preferably embodiment of this invention.

FIG. 2 is the state schematic diagram after the group controller initialization in preferably embodiment of this invention.

FIG. 3 is the system state schematic diagram when user joins the group in preferably embodiment of this invention.

FIG. 4 is the group controller's computing process when user joins the group in preferably embodiment of this invention.

FIG. 5 is process of user computing the group key when user joins the group in preferably embodiment of this invention.

FIG. 6 is the system state schematic diagram when user leaves the group in preferably embodiment of this invention.

FIG. 7 is the group controller's computing process when user leaves the group in preferably embodiment of this invention.

FIG. 8 is the process of user computing the group key when user leaves the group in preferably embodiment of this invention.

FIG. 9 is the system state schematic diagram when users leave and join the group simultaneously in preferably embodiment of this invention.

FIG. 10 is the group controller's computing process when users leave and join the group simultaneously in preferably embodiment of this invention.

FIG. 11 is the process of user computing the group key when users leave and join the group simultaneously in preferably embodiment of this invention.

FIG. 12 is the system state schematic diagram after users leave and join the group simultaneously in preferably embodiment of this invention.

### DETAILED DESCRIPTION OF THE INVENTION

Following is a detailed description of example embodiments of the invention depicted in the accompanying drawings. However, the amount of detail offered is not intended to limit the anticipated variations or embodiments.

### Embodiment

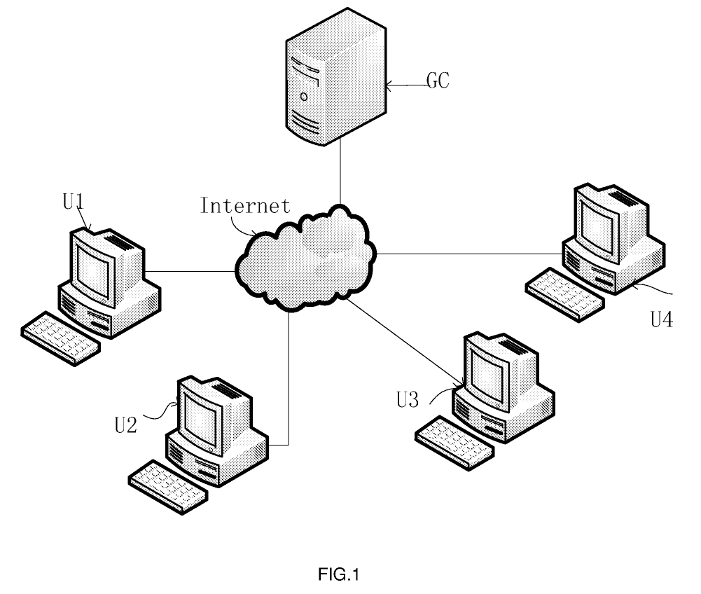

A typical secure group communication system architecture is as illustrated in FIG. 1, which consists of group controller (GC) and four group members U₁,U₂,U₃,U₄. The GC connects with group members via internet.

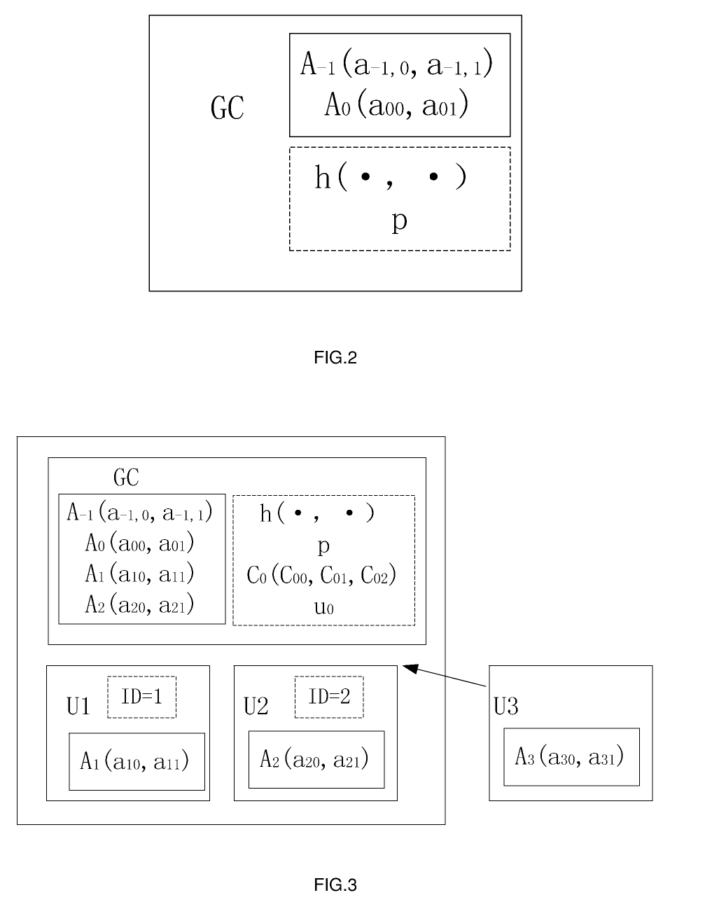

As shown in FIG. 2, the GC setups some relevant parameters, where private parameters are in solid frame and public parameters are in dotted line frame. Correspondingly, the two-dimensional points A₋₁,A₀ are private, and the secure hash function h(·,·) with two input parameters and the large prime p are public. All the computations of embodiment are over the finite field GF(p).

As shown in FIG. 3, U₁ and U₂ have constituted a group, while the group is preparing to admit U₃.

As the first member in the group, U₁'s joining process is as follows: after authenticating U₁, the GC assigns identifier ID=1 to U₁. In the meantime, U₁ should choose a two-dimensional point A₁(a₁₀,a₁₁), and then transmits A₁ to the GC via a secure channel, where a₁₀≠a₁₁,a₁₀≠0, and a₁₁≠0.

The GC stores the point A₁(a₁₀,a₁₁), then selects a mapping parameter u₀ and maps GC's private information and U₁'s private information to the points in a multi-dimensional space.

The GC computes B₋₁(b_{-1,0},b_{-1,1})=(h(a_{-1,0},u₀),h(a_{-1,1},u₀)), B₀(b_{0,0},b_{0,1})=(h(a_{0,0},u₀),h(a_{0,1},u₀)), B₁(b_{1,0},b_{1,1})=(h(a_{1,0},u₀),h(a_{1,1},u₀)), and then adjusts the subscripts of B₋₁,B₀,B₁: because −1<0<1, B₀(b_{0,0},b_{0,1})=(h(a_{-1,0},u₀),h(a_{-1,1},u₀)), B₁(b_{1,0},b_{1,1})=(h(a_{0,0},u₀),h(a_{0,1},u₀)), B₂(b_{2,0},b_{2,1})=(h(a_{1,0},u₀),h(a_{1,1},u₀))

The GC constructs the following system of equations to calculate the central point C₀(c₀₀,c₀₁) of the hypersphere which is established by B₀,B₁,B₂:

$$\begin{matrix}{( {b}_{00} - {c}_{00} )}^{2} + {( {b}_{01} - {c}_{01} )}^{2} = {R}_{0}^{2} \\ {( {b}_{10} - {c}_{00} )}^{2} + {( {b}_{11} - {c}_{01} )}^{2} = {R}_{0}^{2} \\ {( {b}_{20} - {c}_{00} )}^{2} + {( {b}_{21} - {c}_{01} )}^{2} = {R}_{0}^{2}\end{matrix} \}$$

By subtracting the first equation from the second one, and subtracting the second equation from the third one, a system of linear equations can be obtained:

$$\begin{matrix}2 ( {b}_{00} - {b}_{10} ) {c}_{00} + 2 ( {b}_{01} - {b}_{11} ) {c}_{01} = {b}_{00}^{2} + {b}_{01}^{2} - {b}_{10}^{2} - {b}_{11}^{2} \\ 2 ( {b}_{10} - {b}_{20} ) {c}_{00} + 2 ( {b}_{11} - {b}_{21} ) {c}_{01} = {b}_{10}^{2} + {b}_{11}^{2} - {b}_{20}^{2} - {b}_{21}^{2}\end{matrix} \}$$

If 2(b₀₀−b₁₀)·2(b₁₁−b₂₁)−2(b₁₀−b₂₀)·2(b₀₁−b₁₁)≠0, then the above system of equations has one and only one solution. Otherwise, re-select the parameter u₀, re-compute the points B₀,B₁,B₂, and then re-solve the system of linear equations.

The GC delivers the central points C₀(c₀,c₁) and the mapping parameter u₀ to the user U₁ via open channel.

The member U₁ calculates its group key:

K₁=R₀²−∥C₀∥²=h(a₁₀,u₀)²+h(a₁₁,u₀)²−2h(a₁₀,u₀)c₀₀−2h(a₁₁,u₀)c₀₁.

So far, U₁ has joined the group. Due to U₂'s joining process is same as U₃'s, only U₃'s joining process will be described in detail.

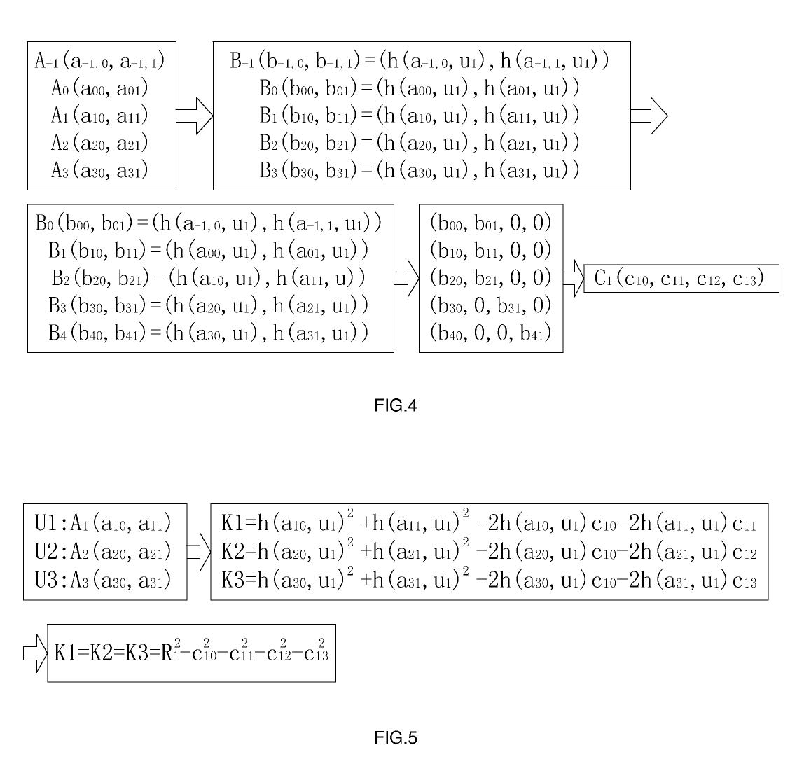

As shown in FIG. 4, the GC stores U₃'s private information A₃(a₃₀,a₃₁) after U₃ is admitted to join the group. The GC randomly selects a new mapping parameter u₁ in random and maps A₋₁,A₀,A₁,A₂,A₃ to the points in a multi-dimensional space respectively, and then calculates the central point C₁ of the hypersphere:

The GC selects the mapping parameter u₁ and converts A₋₁,A₀,A₁,A₂,A₃ to B₋₁(b_{-1,0},b_{-1,1})=(h(a_{-1,0},u₁),h(a_{-1,1},u₁)), B₀(b_{0,0},b_{0,1})=(h(a_{0,0},u₁),h(a_{0,1},u₁)), B₁(b_{1,0},b_{1,1})=(h(a_{1,0},u₁),h(a_{1,1},u₁)), B₂(b_{2,0},b_{2,1})=(h(a_{2,0},u₁),h(a_{2,1},u₁)), B₃(b_{3,0},b_{3,1})=(h(a_{3,0},u₁),h(a_{3,1},u₁)) by using hash function h(·,·) with two input parameters. The GC adjusts the subscripts of B₋₁,B₀,B₁,B₂,B₃: because −1<0<1<2<3, B₀(b_{0,0},b_{0,1})=(h(a_{-1,0},u₁),h(a_{-1,1},u₁)), B₁(b_{1,0},b_{1,1})=(h(a_{0,0},u₁),h(a_{0,1},u₁)), B₂(b_{2,0},b_{2,1})=(h(a_{1,0},u₁),h(a_{1,1},u₁)), B₃(b_{3,0},b_{3,1})=(h(a_{2,0},u₁),h(a_{2,1},u₁)), and B₄(b_{4,0},b_{4,1})=(h(a_{3,0},u₁),h(a_{3,1},u₁)). And then the GC expands B₀,B₁,B₂,B₃,B₄ to become points in a multi-dimensional space: B₀ and B₁ that are transformed from the GC's private parameters A₋₁ and A₀ are supplemented two zeros to become four-dimensional vectors (b₀₀,b₀₁,0,0) and (b₁₀,b₁₁,0,0), B₂,B₃ and B₄ which are transformed from the user's private parameters A₁,A₂ and A₃ are supplemented to become (b₂₀,b₂₁,0,0),(b₃₀,0,b₃₁,0) and (b₄₀,0,0,b₄₁). If [2(b₀₀−b₁₀)·2(b₁₁−b₂₁)−2(b₁₀−b₂₀)·2(b₀₁−b₁₁)]·(−2b₃₁)·(−2b₄₁)=0, then re-select new mapping parameter u₁ and recalculate the points Bⱼ, where j=0, 1, 2, 3, 4.

The GC calculates the central point C₁(c₁₀,c₁₁,c₁₂,c₁₃) of the hypersphere which is established by Bⱼ: By applying the coordinates of the points (b₀₀,b₀₁,0,0),(b₁₀,b₁₁,0,0),(b₂₀,b₂₁,0,0),(b₃₀,0,b₃₁,0), and (b₄₀,0,0,b₄₁) to (x₀−c₁₀)²+(x₁−c₁₁)²+(x₂−c₁₂)²+(x₃−c₁₃)²=R₁², a system of equations an be obtained:

$$\begin{matrix}{( {b}_{00} - {c}_{10} )}^{2} + {( {b}_{01} - {c}_{11} )}^{2} + {( 0 - {c}_{12} )}^{2} + {( 0 - {c}_{13} )}^{2} = {R}_{1}^{2} \\ \begin{matrix}{( {b}_{10} - {c}_{10} )}^{2} + {( {b}_{11} - {c}_{11} )}^{2} + {( 0 - {c}_{12} )}^{2} + {( 0 - {c}_{13} )}^{2} = {R}_{1}^{2} \\ {( {b}_{20} - {c}_{10} )}^{2} + {( {b}_{21} - {c}_{11} )}^{2} + {( 0 - {c}_{12} )}^{2} + {( 0 - {c}_{13} )}^{2} = {R}_{1}^{2} \\ {( {b}_{30} - {c}_{10} )}^{2} + {( 0 - {c}_{11} )}^{2} + {( {b}_{31} - {c}_{12} )}^{2} + {( 0 - {c}_{13} )}^{2} = {R}_{1}^{2} \\ {( {b}_{40} - {c}_{10} )}^{2} + {( 0 - {c}_{11} )}^{2} + {( 0 - {c}_{12} )}^{2} + {( {b}_{41} - {c}_{13} )}^{2} = {R}_{1}^{2}\end{matrix}\end{matrix} \}$$

Subtract the j-th equation from the (j+1)-th equation:

$$[ \begin{matrix}2 ( {b}_{00} - {b}_{10} ) & 2 ( {b}_{01} - {b}_{11} ) & 0 & 0 \\ 2 ( {b}_{10} - {b}_{20} ) & 2 ( {b}_{11} - {b}_{21} ) & 0 & 0 \\ 2 ( {b}_{20} - {b}_{30} ) & 2 {b}_{21} & - 2 {b}_{31} & 0 \\ 2 ( {b}_{30} - {b}_{40} ) & 0 & 2 {b}_{31} & - 2 {b}_{41}\end{matrix} ] [ \begin{matrix}{c}_{10} \\ {c}_{11} \\ {c}_{12} \\ {c}_{13}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2}\end{matrix} ]$$

The condition [2(b₀₀−b₁₀)·2(b₁₁−b₂₁)−2(b₁₀−b₂₀)·2(b₀₁−b₁₁)]·(−2b₃₁)·(−2b₄₁)≠0 guarantees that the above system of equations has one and only one solution.

As shown in FIG. 5, the members U₁,U₂ and U₃ calculate their mapping points after the GC publishes the central point C₁(c₁₀,c₁₁,c₁₂,c₁₃) and the mapping parameter u₁, and then compute their group keys. By applying the coordinates of U₁'s private information A₁(a₁₀,a₁₁), identifier ID=1 and the GC's public information to the formula, U₁ can calculate the group key as K₁=R₁²−∥C₁∥²=h(a₁₀,u₁)²+h(a₁₁,u₁)²−2h(a₁₀,u₁)c₁₀−2h(a₁₁,u₁)c₁₁, where R₁ is the radius of the four dimensional hypersphere in FIG. 4. The processes for U₂ and U₃ to compute the group key are the same as U₁.

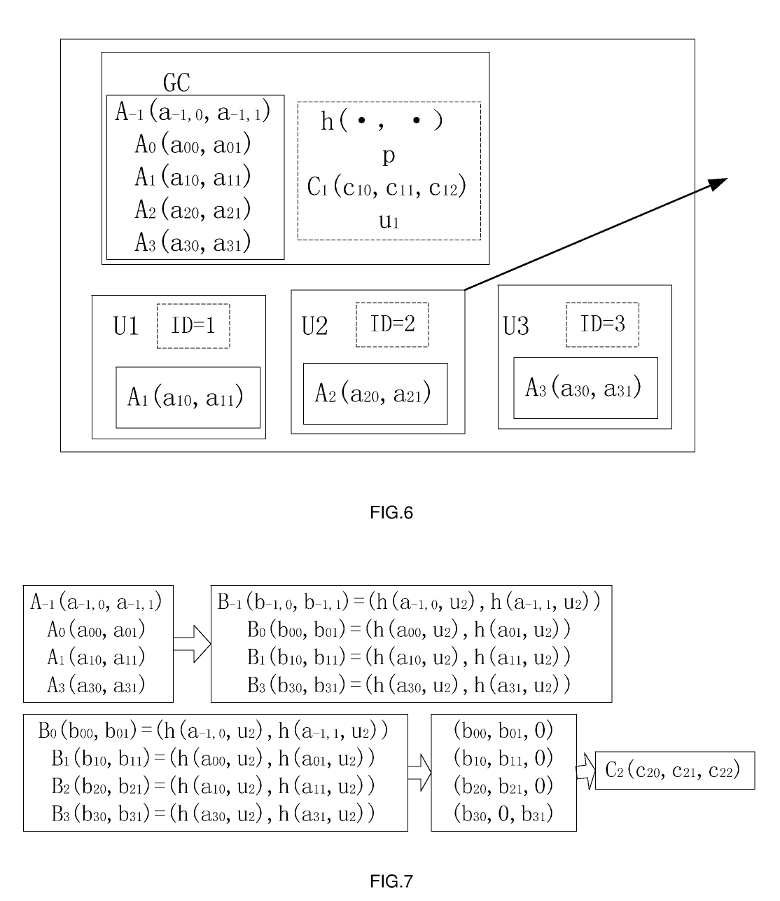

As shown in FIG. 6, U₁,U₂ and U₃ have constituted a group, while U₂ is going to leave the group.

As shown in FIG. 7, after U₂ leaves the group, the GC deletes U₂'s private information A₂. The GC randomly selects a new mapping parameter u₂, and maps A₋₁,A₀,A₁,A₃ to the points in a multi-dimensional space respectively, and then calculates the central point C₂ of the hypersphere:

The GC selects the mapping parameter u₂ and converts A₋₁,A₀,A₁,A₃ to B₋₁(b_{-1,0},b_{-1,1})=(h(a_{-1,0},u₂),h(a_{-1,1},u₂)), B₀(b_{0,0},b_{0,1})=(h(a_{0,0},u₂),h(a_{0,1},u₂)), B₁(b_{1,0},b_{1,1})=(h(a_{1,0},u₂),h(a_{1,1},u₂)), B₃(b_{3,0},b_{3,1})=(h(a_{3,0},u₂),h(a_{3,1},u₂)) by using hash function h(·,·) with two input parameters. The GC adjusts the subscripts of B₋₁,B₀,B₁,B₃: because −1<0<1<3, B₀(b_{0,0},b_{0,1})=(h(a_{-1,0},u₂),h(a_{-1,1},u₂)), B₁(b_{1,0},b_{1,1})=(h(a_{0,0},u₂),h(a_{0,1},u₂)), B₂(b_{2,0},b_{2,1})=(h(a_{1,0},u₂),h(a_{1,1},u₂)), B₃(b_{3,0},b_{3,1})=(h(a_{3,0},u₂),h(a_{3,1},u₂)). And then the GC expands B₀,B₁,B₂,B₃ to become points in a multi-dimensional space: B₀ and B₁ that are transformed from the GC's private parameters A₋₁ and A₀ are supplemented zero to become three dimensional vectors (b₀₀,b₀₁,0) and (b₁₀,b₁₁,0), B₂ and B₃ that are transformed from the user's private parameters A₁ and A₃ are supplemented zero to become four dimensional vectors (b₂₀,b₂₁,0) and (b₃₀,b₃₁,0). If [2(b₀₀−b₁₀)·2(b₁₁−b₂₁)−2(b₁₀−b₂₀)·2(b₀₁−b₁₁)]·(−2b₃₁)=0, then re-select another mapping parameter u₂ and recalculate the points Bⱼ, where j=0, 1, 2, 3. Finally, the central point of the hypersphere C₂(c₂₀,c₂₁,c₂₂) constructed by the extended points are calculated. The processes to calculate C₂ is the same as C₁, therefore we will not go into details to calculate C₂.

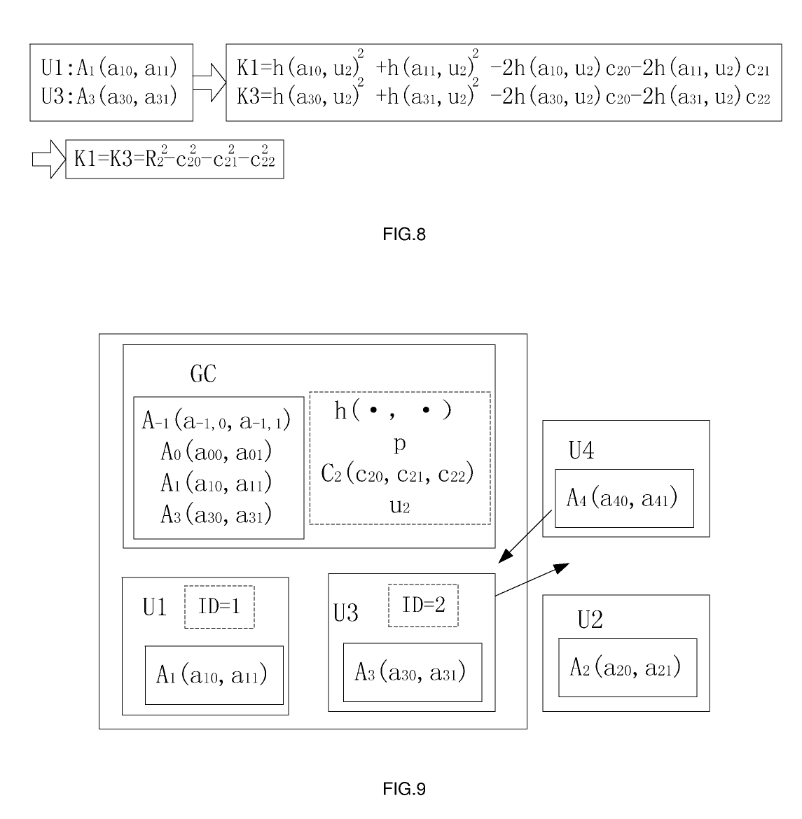

As shown in FIG. 8, after the GC publishes the central point C₂, mapping parameter u₂ and U₂'s identifier, U₁ and U₃ calculate their mapping points in a multi-dimensional space respectively, and then calculates the central point C₁ of the hypersphere:

U₁ and U₃ change their identifier: specifically, U₁'s identifier is 1, comparing with all the leaving members' identifiers, discovering that U₁'s identifier is the smallest one, so e=0, ID=ID−0, then U₁ changes its identifier as ID=1−0=1. U₃'s identifier is 3, comparing with all the leaving members' identifiers, discovering that U₂'s identifier is less than its, so e=1, ID=ID−e, then U₃ changes its identifier as ID=3−1=2. By applying the coordinates of U₁'s private information A₁(a₁₀,a₁₁), identifier ID=1 and the GC's public information to the formula, U₁ can calculate the group key as K₁=R₂²−∥C₂∥²=h(a₁₀,u₂)²+h(a₁₁,u₂)²−2h(a₁₀,u₂)c₂₀−2h(a₁₁,u₂)c₂₁, where R₂ is the radius of the three dimensional hypersphere in FIG. 7. By applying the coordinates of U₃'s private information A₃(a₃₀,a₃₁), identifier ID=2 and the GC's public information to the formula, U₃ can calculate the group key as K₃=R₂²−∥C₂∥²=h(a₃₀,u₂)²+h(a₃₁,u₂)²−2h(a₃₀,u₂)c₂₀−2h(a₃₁,u₂)c₂₂.

As shown in FIG. 9, U₁ and U₃ have constituted a group after U₂ leaves the group. The system state will have new changes that U₃ will leave the group and U₄ will join in.

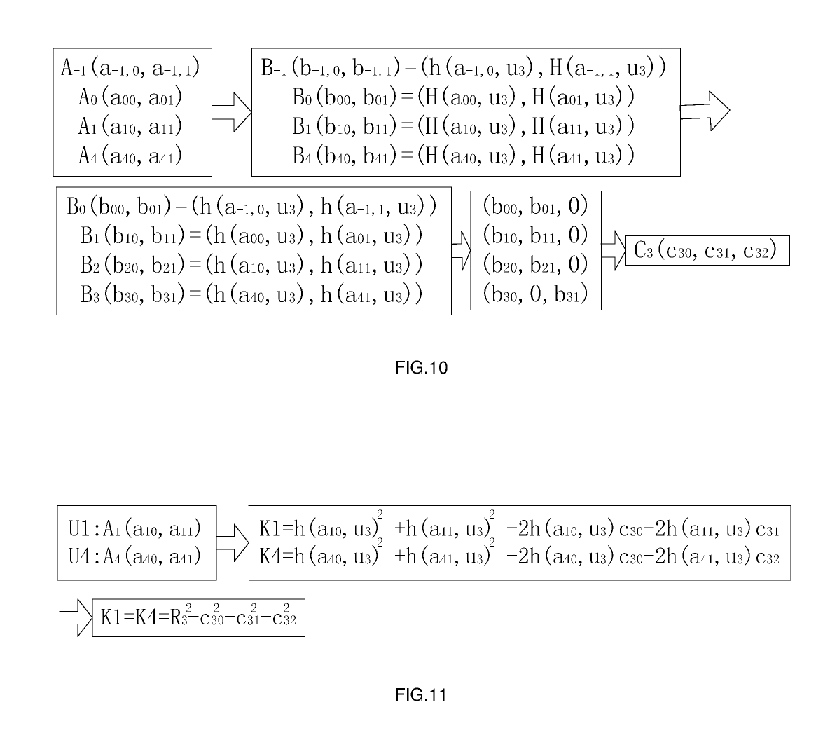

As shown in FIG. 10, after U₃ leaves and U₄ join the group, the GC firstly deletes U₃'s private information A₃, stores A₄ and assigns identifier ID=3 to U₄. Then the GC selects a new mapping parameter u₃, and maps A₋₁,A₀,A₁,A₄ to the points in a multi-dimensional space respectively. Finally, the GC calculates the central point C₃ of the hypersphere:

The GC selects the mapping parameter u₃ and converts A₋₁,A₀,A₁,A₄ to B₋₁(b_{-1,0},b_{-1,1})=(h(a_{-1,0},u₃),h(a_{-1,1},u₃)), B₀(b_{0,0},b_{0,1})=(h(a_{0,0},u₃),h(a_{0,1},u₃)), B₁(b_{1,0},b_{1,1})=(h(a_{1,0},u₃),h(a_{1,1},u₃)), B₄(b_{4,0},b_{4,1})=(h(a_{4,0},u₃),h(a_{4,1},u₃)) by using hash function h(·,·) with two input parameters. The GC adjusts the subscripts of B₋₁,B₀,B₁,B₄: because −1<0<1<4, B₀(b_{0,0},b_{0,1})=(h(a_{-1,0},u₃),h(a_{-1,1},u₃)), B₁(b_{1,0},b_{1,1})=(h(a_{0,0},u₃),h(a_{0,0},u₃)), B₂(b_{2,0},b_{2,1})=(h(a_{1,0},u₃),h(a_{1,1},u₃)), B₃(b_{3,0},b_{3,1})=(h(a_{4,0},u₃),h(a_{4,1},u₃)). And then the GC expands B₀,B₁,B₂,B₃ to become points in a multi-dimensional space: B₀ and B₁ that are transformed from the GC's private parameters A₋₁ and A₀ are supplemented zero to become three dimensional vectors (b₀₀,b₀₁,0) and (b₁₀,b₁₁,0), B₂ and B₃ which are transformed from the user's private parameters A₁ and A₄ are supplemented zero to become (b₂₀,b₂₁,0) and (b₃₀,0,b₃₁). If [2(b₀₀−b₁₀)·2(b₁₁−b₂₁)−2(b₁₀−b₂₀)·2(b₀₁−b₁₁)]·(−2b₃₁)=0, then re-select new mapping parameter u₃ and recalculate the points Bⱼ, where j=0, 1, 2, 3. Finally, the central point of the hypersphere C₃(c₃₀,c₃₁,c₃₂) constructed by the extended points are calculated. The processes to calculate C₃ is the same as C₁, therefore we will not go into details to calculate C₃.

As shown in FIG. 11, after the GC publishes the central point C₃, mapping parameter u₃ and leaving member U₃'s identifier, the processes for the remnant members U₁ and U₄ to calculate their group keys are as follows:

U₁'s identifier is 1, by comparing with all the leaving members' identifiers, discovering that U₁'s identifier is the smallest, so e=0, ID=ID−0, then U₁ changes its identifier as ID=1−0=1. By applying the coordinates of U₁'s private information A₁(a₁₀,a₁₁), identifier ID=1 and the GC's public information to the formula, U₁ can calculate the group key as K₁=R₃²−∥C₃∥²=h(a₁₀,u₃)²+h(a₁₁,u₃)²−2h(a₁₀,u₃)c₃₀−2h(a₁₁,u₃)c₃₁, where R₃ is the radius of the 3-dimensional sphere in FIG. 10.

U₄'s identifier is 3, by comparing with all the leaving members' identifiers, discovering that only leaving member U₃'s identifier is less than its, so e=1, ID=ID−e and U₄ changes its identifier as ID=3−1=2. By applying the coordinates of U₄'s private information A₄(a₄₀,a₄₁), identifier ID=2 and the GC's public information to the formula, U₄ can calculate the group key as K₄=R₃²−∥C₃∥²=h(a₄₀,u₃)²+h(a₄₁,u₃)²−2h(a₄₀,u₃)c₃₀−2h(a₄₁,u₃)c₃₁.

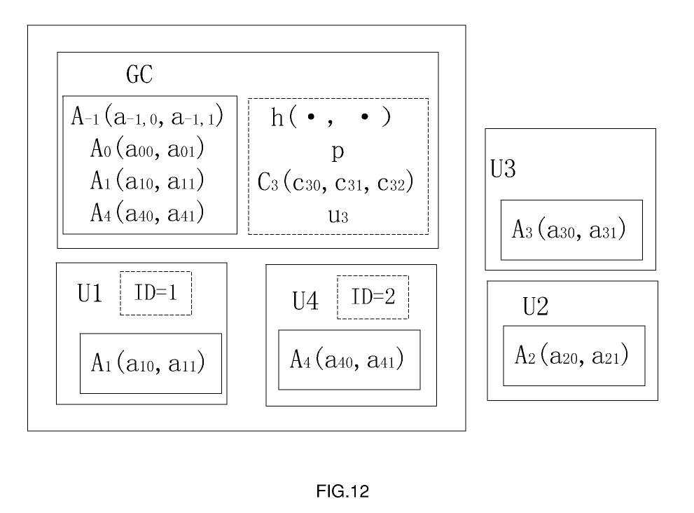

As shown in FIG. 12, U₁ and U₄ have constituted a group after U₃ leaves and U₄ joins in the group.

The above embodiment is a preferably embodiment of this invention. However, the amount of detail offered is not intended to limit the anticipated variations or embodiments, but on the contrary, the intention is to cover all modifications, equivalents, and alternatives falling within the spirit and scope of the present invention as defined by the appended claims.

We claim:

1. A secure group key management approach based upon N-dimensional hypersphere, characterized in that it comprises the following stages:
(1) Initialization: The GC (Group Controller) selects its private information, sets group finite field GF(p) and hash function h(·,·) of two variables, and then lets the first member join the group, where GF(p) designates finite field where group computation processes;
(2) Adding Members: The GC assigns identifiers to the new joining members after they are admitted, in the meantime, each new joining member should transmit its private information to the GC via a secure channel; the GC selects a mapping parameter, and maps this parameter and each new member's private information to the points in a multi-dimensional space; if the hypersphere can not be determined by the points, the GC should select another mapping parameter and re-map; the GC calculates the central point of the hypersphere which is established by the points, and then publishes the central point and the mapping parameter; each member in the group calculates the mapping point by using its identifier, the central point and the mapping parameter, and then calculates its own group key;
(3) Removing Members: The GC deletes the leaving members' private information, selects new mapping parameters, and then maps parameters and each new member's private information into the points in the hypersphere; if the hypersphere can not be determined by the points, the GC should select another mapping parameter and re-map; the GC publishes the central points, the mapping parameters and the identifiers of the leaving members; the remnant members are sorted by identifiers and re-assigned new identifiers as 1, 2, 3, 4 . . . n; each remnant user in the group calculates the mapping point by using its new identifier, the central point and the mapping parameter, and then calculates its own group key;
(4) Massive adding and removing: The GC deletes the leaving members' private information, assigns identifiers to the new joining members after they are admitted, in the meantime, each new joining member should transmit its private information to the GC via a secure channel; the GC selects mapping parameters, and then maps this parameters and each new member's private information into the points in the hypersphere; if the hypersphere can not be determined by the points, the GC should select another mapping parameter and re-map; the GC calculates the central point of the hypersphere which is established by the points, and then publishes the central point, the mapping parameter and the identifiers of the leaving members; the remnant members are sorted by identifiers and re-assigned new identifiers as 1, 2, 3, 4 . . . n; each remnant user in the group calculates the mapping point by using its new identifier, the central point and the mapping parameter, and then calculates its own group key.

2. According to the secure group key management approach based upon N-dimensional hypersphere which is described in claim 1, characterized in that the stage (1) which is initialization comprises the following steps:
(1.1) The GC selects two different two-dimensional points A₋₁(a_{-1,0},a_{-1,1}), A₀(a_{0,0},a_{0,1}) and keeps them secret; a large prime number p and a secure hash function h(·,·) are chosen and made public by the GC,
where p designates the finite field GF(p) over which all the group computations are conducted, and a_{-1,0},a_{-1,1},a_{0,0},a_{0,1} are the integers over GF(p);
(1.2) Let the first member U₁ join the group; in general, U₁ is the group initiator:
a) After authenticating U₁, the GC assigns identifier ID=1 to U₁; in the meantime, U₁ should choose a two-dimensional point A₁(a₁₀,a₁₁), and then transmits A₁ to GC via a secure channel, where a_{0,0},a_{0,1} are the integers over GF(p), satisfying a₁₀≠a₁₁,a₁₀≠0, and a₁₁≠0;
b) The GC stores the point A₁(a₁₀,a₁₁), then selects a mapping parameter u₀ and maps GC's private information and U₁'s private information to the points in a multi-dimensional space:
For j=0, 1, 2, computes Bⱼ(bⱼ₀,bⱼ₁)=(h(a_{j-1,0},u₀),h(a_{j-1,1},u₀)),
If 2(b₀₀−b₁₀)·2(b₁₁−b₂₁)−2(b₁₀−b₂₀)·2(b₀₁−b₁₁)=0, re-selects another mapping parameter u₀ and re-calculates the points Bⱼ, where u₀ is a random integer, a_{j-1,0} and a_{j-1,1} are the components of private information Aⱼ₋₁, bⱼ₀ and bⱼ₁ are the results of hash function h(·,·) applying to a_{j-1,0} and a_{j-1,1} respectively;
c) The GC constructs the following system of equations to calculate the central point C₀(c₀₀,c₀₁) of the hypersphere:
$$\begin{matrix}{( {b}_{00} - {c}_{00} )}^{2} + {( {b}_{01} - {c}_{01} )}^{2} = {R}_{0}^{2} \\ {( {b}_{10} - {c}_{00} )}^{2} + {( {b}_{11} - {c}_{01} )}^{2} = {R}_{0}^{2} \\ {( {b}_{20} - {c}_{00} )}^{2} + {( {b}_{21} - {c}_{01} )}^{2} = {R}_{0}^{2}\end{matrix} \}$$
By subtracting the first equation from the second one, and subtracting the second equation from the third one, we can get a system of linear equations:
$$\begin{matrix}2 ( {b}_{00} - {b}_{10} ) {c}_{00} + 2 ( {b}_{01} - {b}_{11} ) {c}_{01} = {b}_{00}^{2} + {b}_{01}^{2} - {b}_{10}^{2} - {b}_{11}^{2} \\ 2 ( {b}_{10} - {b}_{20} ) {c}_{00} + 2 ( {b}_{11} - {b}_{21} ) {c}_{01} = {b}_{10}^{2} + {b}_{11}^{2} - {b}_{20}^{2} - {b}_{21}^{2}\end{matrix} \}$$
The condition 2(b₀₀−b₁₀)·2(b₁₁−b₂₁)−2(b₁₀−b₂₀)·2(b₀₁−b₁₁)≠0 in b) guarantees that the above system of equations has one and only one solution;
d) The GC delivers the central points C₀(c₀,c₁) and the mapping parameter u₀ to the member U₁ via open channel;
e) The member U₁ calculates its group key:
K₁=R₀²−∥C₀∥²=h(a₁₀,u₀)²+h(a₁₁,u₀)²−2h(a₁₀,u₀)c₀₀−2h(a₁₁,u₀)c₀₁,
where R₀ is the radius of the circle whose central point is C₀, ∥C₀∥²=c₀₀²+c₀₁², and K₁ is the group key that is computed by the member U₁.

3. According to the secure group key management approach based upon N-dimensional hypersphere which is described in claim 1, characterized in that the stage (2) of adding member comprises the following steps:
(2.1) Suppose there are n−δ members in the group, where n−δ≧1 and δ≧1, there are δ new members want to join the group; after the new members are admitted, there should be n members in the group, and every new member is assigned new identifier as (n−δ)+1, (n−δ)+2, . . . , (n−δ)+δ; for x=(n−δ)+1, (n−δ)+2, . . . , (n−δ)+δ, each new member Uₓ selects its private two-dimensional point Aₓ(aₓ₀,aₓ₁) where aₓ₀≠aₓ₁,aₓ₀≠0,aₓ₁≠0, and transmits the point Aₓ to the GC via a secure channel; the GC stores Aₓ(aₓ₀,aₓ₁) securely;
(2.2) The GC selects a mapping parameter u₁, and maps its and each member's private information to the points in a multi-dimensional space:
The GC Computes Bᵢ(bᵢ₀,bᵢ₁)=(h(aᵢ₀,u₁),h(aᵢ₁,u₁)) by utilizing the two dimensional point Aᵢ(aᵢ₀,aᵢ₁) that the GC stores, where Aᵢ(aᵢ₀,aᵢ₁) is a 2-dimensional point in the group, Bᵢ(bᵢ₀,bᵢ₁) is the result of hash function applying to the values of 2-dimensional in Aᵢ(aᵢ₀,aᵢ₁), bᵢ₀ and bᵢ₁ are the results of hash function applying to aᵢ₀ and aᵢ₁ respectively, i is the subscript of member's private information; the GC re-assigns the subscripts of Bᵢ according to the values of original subscripts, and let the subscripts begin from 0; then the new set of points Bᵢ is now {Bᵣ|r=0, 1, . . . , n+1};
If
$$[ 2 ( {b}_{00} - {b}_{10} ) \cdot 2 ( {b}_{11} - {b}_{21} ) - 2 ( {b}_{10} - {b}_{20} ) \cdot 2 ( {b}_{01} - {b}_{11} ) ] \cdot {\prod }_{t = 3}^{n + 1} ( - 2 {b}_{t 1} ) = 0 ,$$
GC repeats step (2.2);
(2.3) The GC computes C₁(c₁₀, c₁₁, c₁₂, . . . , c₁ₙ), the central point of the hypersphere that established by Bᵣ:
Expanding Bᵣ: The GC expends Bᵣ to become a (n+1)-dimensional point Vᵣ; for r=0,1, Bᵣ is supplemented n−1 zeros to become Vᵣ(bᵣ₀, bᵣ₁, 0 . . . 0); for r=2, 3, . . . , n+1, let Vᵣ=(bᵣ₀, 0, . . . , 0, bᵣ₁, 0 . . . 0), where the number of zero between bᵣ₀ and bᵣ₁ is r−2, and there are n+1−r zeros supplemented after bᵣ₁;
The GC constructs the system of equations:
$$\begin{matrix}{( {b}_{00} - {c}_{10} )}^{2} + {( {b}_{01} - {c}_{11} )}^{2} + {( 0 - {c}_{12} )}^{2} + {( 0 - {c}_{13} )}^{2} … + {( 0 - {c}_{1 n} )}^{2} = {R}_{1}^{2} \\ {( {b}_{10} - {c}_{10} )}^{2} + {( {b}_{11} - {c}_{11} )}^{2} + {( 0 - {c}_{12} )}^{2} + {( 0 - {c}_{13} )}^{2} … + {( 0 - {c}_{1 n} )}^{2} = {R}_{1}^{2} \\ {( {b}_{20} - {c}_{10} )}^{2} + {( {b}_{21} - {c}_{11} )}^{2} + {( 0 - {c}_{12} )}^{2} + {( 0 - {c}_{13} )}^{2} … + {( 0 - {c}_{1 n} )}^{2} = {R}_{1}^{2} \\ {( {b}_{30} - {c}_{10} )}^{2} + {( 0 - {c}_{11} )}^{2} + {( {b}_{31} - {c}_{12} )}^{2} + {( 0 - {c}_{13} )}^{2} … + {( 0 - {c}_{1 n} )}^{2} = {R}_{1}^{2} \\ {( {b}_{40} - {c}_{10} )}^{2} + {( 0 - {c}_{11} )}^{2} + {( 0 - {c}_{12} )}^{2} + {( {b}_{41} - {c}_{13} )}^{2} … + {( 0 - {c}_{1 n} )}^{2} = {R}_{1}^{2} \\ … \\ {( {b}_{n + 1 , 0} - {c}_{10} )}^{2} + {( 0 - {c}_{11} )}^{2} + {( 0 - {c}_{12} )}^{2} + {( 0 - {c}_{13} )}^{2} … + {( {b}_{n + 1 , 1} - {c}_{1 n} )}^{2} = {R}_{1}^{2}\end{matrix} \}$$
Subtracts the j-th equation from the (j+1)-th equation:
$$[ \begin{matrix}2 ( {b}_{00} - {b}_{10} ) & 2 ( {b}_{01} - {b}_{11} ) & 0 & … & … & 0 \\ 2 ( {b}_{10} - {b}_{20} ) & 2 ( {b}_{11} - {b}_{21} ) & 0 & … & … & 0 \\ 2 ( {b}_{20} - {b}_{30} ) & 2 {b}_{21} & - 2 {b}_{31} & 0 & … & 0 \\ 2 ( {b}_{30} - {b}_{40} ) & 0 & 2 {b}_{31} & - 2 {b}_{41} & 0 … & 0 \\ & & … & & & \\ 2 ( {b}_{n 0} - {b}_{n + 1 , 0} ) & 0 & … & 0 & 2 {b}_{n 1} & - 2 {b}_{n + 1 , 1}\end{matrix} ] \\ [ \begin{matrix}{c}_{10} \\ {c}_{11} \\ {c}_{12} \\ {c}_{13} \\ … \\ {c}_{1 n}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2} \\ … \\ {b}_{n 0}^{2} + {b}_{n 1}^{2} - {b}_{n + 1 , 0}^{2} - {b}_{n + 1 , 1}^{2}\end{matrix} ]$$
The condition
$$[ 2 ( {b}_{00} - {b}_{10} ) \cdot 2 ( {b}_{11} - {b}_{21} ) - 2 ( {b}_{10} - {b}_{20} ) \cdot 2 ( {b}_{01} - {b}_{11} ) ] \cdot {\prod }_{t = 3}^{n + 1} ( - 2 {b}_{t 1} ) \neq 0$$
in (2.2) guarantees that the above system of equations has one and only one solution;
(2.4) The GC multicasts the central point C₁(c₁₀, c₁₁, c₁₂, . . . , c₁ₙ) and the mapping parameter u₁ to all the group members via open channel;
(2.5) Each group member calculates the group key by using its private point Aᵢ(aᵢ₀,aᵢ₁) and the public information C₁(c₁₀, c₁₁, c₁₂ . . . , c₁ₙ), u₁:
Kᵢ=R₁²−∥C₁∥²=h(aᵢ₀,u₁)²+h(aᵢ₁,u₁)²−2h(aᵢ₀,u₁)c₁₀−2h(aᵢ₁,u₁)c_{1d}, where Kᵢ is the group key calculated by the user whose private information's subscript is i, aᵢ₀,aᵢ₁ are the components of private information Aᵢ, d is the user's identifier, R₁ is the radius of the hypersphere, and
$${‖ {C}_{1} ‖}^{2} = {\sum }_{m = 0}^{n} {c}_{1 m}^{2} .$$

4. According to the secure group key management approach based upon n-dimensional hypersphere which is described in claim 1, characterized in that the stage (3) of removing member comprises the following steps:
(3.1) Suppose there are n+f members in the group, and there are f members want to leave the group, where n+f≧2 and f≧1; after f members leave, there should be n members in the group; the GC deletes the leaving members' private two-dimensional points;
(3.2) The GC selects a mapping parameter u₂, maps its and the remnant member's private information to the points in a multi-dimensional space:
The GC Computes Bᵢ(bᵢ₀,bᵢ₁)=(h(aᵢ₀,u₂),h(aᵢ₁,u₂)) by utilizing the two dimensional point Aᵢ(aᵢ₀,aᵢ₁) that the GC stores; the GC re-assigns the subscripts of Bᵢ according to the values of original subscripts, and let the subscripts begin from 0; then the new set of points Bᵢ is now {Bᵣ|r=0, 1, . . . , n+1};
if
$$[ 2 ( {b}_{00} - {b}_{10} ) \cdot 2 ( {b}_{11} - {b}_{21} ) - 2 ( {b}_{10} - {b}_{20} ) \cdot 2 ( {b}_{01} - {b}_{11} ) ] \cdot {\prod }_{t = 3}^{n + 1} ( - 2 {b}_{t 1} ) = 0 ,$$
repeat step (3.2);
(3.3) The GC computes C₂(c₂₀,c₂₁,c₂₂, . . . , c₂ₙ), the central point of the hypersphere that established by Bᵣ:
Expanding Bᵣ: The GC expends Bᵣ to become a (n+1)-dimensional point Vᵣ; for r=0,1, Bᵣ is supplemented n−1 zeros to become Vᵣ(bᵣ₀, bᵣ₁, 0 . . . 0); for r=2, 3, . . . , n+1, let Vᵣ=(bᵣ₀, 0, . . . , 0, bᵣ₁, 0 . . . 0), where the number of zero between bᵣ₀ and bᵣ₁ is r−2, and there are n+1−r zeros supplemented after bᵣ₁;
The GC constructs the system of equations:
$$\begin{matrix}{( {b}_{00} - {c}_{20} )}^{2} + {( {b}_{01} - {c}_{21} )}^{2} + {( 0 - {c}_{22} )}^{2} + {( 0 - {c}_{23} )}^{2} … + {( 0 - {c}_{2 n} )}^{2} = {R}_{2}^{2} \\ {( {b}_{10} - {c}_{20} )}^{2} + {( {b}_{11} - {c}_{21} )}^{2} + {( 0 - {c}_{22} )}^{2} + {( 0 - {c}_{23} )}^{2} … + {( 0 - {c}_{2 n} )}^{2} = {R}_{2}^{2} \\ {( {b}_{20} - {c}_{20} )}^{2} + {( {b}_{21} - {c}_{21} )}^{2} + {( 0 - {c}_{22} )}^{2} + {( 0 - {c}_{23} )}^{2} … + {( 0 - {c}_{2 n} )}^{2} = {R}_{2}^{2} \\ {( {b}_{30} - {c}_{20} )}^{2} + {( 0 - {c}_{21} )}^{2} + {( {b}_{31} - {c}_{22} )}^{2} + {( 0 - {c}_{23} )}^{2} … + {( 0 - {c}_{2 n} )}^{2} = {R}_{2}^{2} \\ {( {b}_{40} - {c}_{20} )}^{2} + {( 0 - {c}_{21} )}^{2} + {( 0 - {c}_{22} )}^{2} + {( {b}_{41} - {c}_{23} )}^{2} … + {( 0 - {c}_{2 n} )}^{2} = {R}_{2}^{2} \\ … \\ {( {b}_{n + 1 , 0} - {c}_{20} )}^{2} + {( 0 - {c}_{21} )}^{2} + {( 0 - {c}_{22} )}^{2} + {( 0 - {c}_{23} )}^{2} … + {( {b}_{n + 1 , 1} - {c}_{2 n} )}^{2} = {R}_{2}^{2}\end{matrix} \}$$
Subtracts the j-th equation from the (j+1)-th equation:
$$[ \begin{matrix}2 ( {b}_{00} - {b}_{10} ) & 2 ( {b}_{01} - {b}_{11} ) & 0 & … & … & 0 \\ 2 ( {b}_{10} - {b}_{20} ) & 2 ( {b}_{11} - {b}_{21} ) & 0 & … & … & 0 \\ 2 ( {b}_{20} - {b}_{30} ) & 2 {b}_{21} & - 2 {b}_{31} & 0 & … & 0 \\ 2 ( {b}_{30} - {b}_{40} ) & 0 & 2 {b}_{31} & - 2 {b}_{41} & 0 … & 0 \\ & & … & & & \\ 2 ( {b}_{n 0} - {b}_{n + 1 , 0} ) & 0 & … & 0 & 2 {b}_{n 1} & - 2 {b}_{n + 1 , 1}\end{matrix} ] \\ [ \begin{matrix}{c}_{20} \\ {c}_{21} \\ {c}_{22} \\ {c}_{23} \\ … \\ {c}_{2 n}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2} \\ … \\ {b}_{n 0}^{2} + {b}_{n 1}^{2} - {b}_{n + 1 , 0}^{2} - {b}_{n + 1 , 1}^{2}\end{matrix} ]$$
The condition
$$[ 2 ( {b}_{00} - {b}_{10} ) \cdot 2 ( {b}_{11} - {b}_{21} ) - 2 ( {b}_{10} - {b}_{20} ) \cdot 2 ( {b}_{01} - {b}_{11} ) ] \cdot {\prod }_{t = 3}^{n + 1} ( - 2 {b}_{t 1} ) \neq 0$$
in (3.2) guarantees that the above system of equations has one and only one solution;
(3.4) The GC multicasts C₂, u₂ and all the identifiers of the leaving members to all the group members via open channel;
(3.5) The remnant members calculate their group keys:
Each remnant member compares its identifier with the identifiers of leaving members and computes the number of leaving members whose identifies less than its, and denoted by e; then each remnant members adjusts its identifier as ID=ID−e, where the value of e calculated by each member may not be the same, and e≧0 and e≦f; each remnant member calculates the group key:
Kᵢ=R₂²−∥C₂|²=h(aᵢ₀,u₂)²+h(aᵢ₁,u₂)²−2h(aᵢ₀, u₂)c₂₀−2h(aᵢ₁,u₂)c_{2d}, where Kᵢ is the group key calculated by the user whose secret's subscript is i, aᵢ₀,aᵢ₁ are the components of private information Aᵢ, d is the user's identifier, R₂ is the radius of the hypersphere, and
$${‖ {C}_{2} ‖}^{2} = {\sum }_{m = 0}^{n} {c}_{2 m}^{2} .$$

5. According to the secure group key management approach based upon N-dimensional hyper-sphere which is described in claim 1, characterized in that the stage (4) of adding and removing members simultaneously comprises the following steps:
(4.1) Suppose there are n+w−v members in the group, where 1≦w≦(n+w−v) and 1≦v; there are w members want to leave, and v new members want to join the group simultaneously; after the membership changes, there should be n members in the group;
The GC deletes the leaving members' private two-dimensional points; for y=(n−v)+1, (n−v)+2, . . . , n, the value of y is assigned as the identifier of the new joining members; each new member U_{y} selects its own private two-dimensional point A_{y}(a_{y0},a_{y1}), where a_{y0}≠a_{y1},a_{y0}≠0,a_{y1}≠0; the user U_{y} transmits the point A_{y}(a_{y0},a_{y1}) to the GC via a secure channel; after the member U_{y} is authenticated, the GC stores A_{y}(a_{y0},a_{y1});
(4.2) The GC selects a mapping parameter u₃, and maps its and the each member's private information to the points in a multi-dimensional space:
The GC computes Bᵢ(bᵢ₀,bᵢ₁)=(h(aᵢ₀,u₃),h(aᵢ₁,u₃)) by utilizing the two dimensional point Aᵢ(aᵢ₀,aᵢ₁) that the GC stores; the GC re-assigns the subscripts of Bᵢ according to the values of original subscripts, and let the subscripts begin from 0; then the new set of points Bᵢ is now {Bᵣ|r=0, 1, . . . , n+1};
if
$$[ 2 ( {b}_{00} - {b}_{10} ) \cdot 2 ( {b}_{11} - {b}_{21} ) - 2 ( {b}_{10} - {b}_{20} ) \cdot 2 ( {b}_{01} - {b}_{11} ) ] \cdot {\prod }_{t = 3}^{n + 1} ( - 2 {b}_{t 1} ) = 0 ,$$
the GC repeats (4.2);
(4.3) The computes C₃(c₃₀, c₃₁, c₃₂, . . . , c₃ₙ), the central point of the hypersphere that established by Bᵣ:
Expanding Bᵣ: The GC expends Bᵣ to become a (n+1)-dimensional point Vᵣ; for r=0,1, Bᵣ is supplemented n−1 zeros to become Vᵣ(bᵣ₀, bᵣ₁, 0 . . . 0); for r=2, 3, . . . , n+1, lets Vᵣ=(bᵣ₀, 0, . . . , 0, bᵣ₁, 0 . . . 0), where the number of zero between bᵣ₀ and bᵣ₁ is r−2, and there are n+1−r zeros supplemented after bᵣ₁;
The GC constructs the system of equations:
$$\begin{matrix}{( {b}_{00} - {c}_{30} )}^{2} + {( {b}_{01} - {c}_{31} )}^{2} + {( 0 - {c}_{32} )}^{2} + {( 0 - {c}_{33} )}^{2} … + {( 0 - {c}_{3 n} )}^{2} = {R}_{3}^{2} \\ {( {b}_{10} - {c}_{30} )}^{2} + {( {b}_{11} - {c}_{31} )}^{2} + {( 0 - {c}_{32} )}^{2} + {( 0 - {c}_{33} )}^{2} … + {( 0 - {c}_{3 n} )}^{2} = {R}_{3}^{2} \\ {( {b}_{20} - {c}_{30} )}^{2} + {( {b}_{21} - {c}_{31} )}^{2} + {( 0 - {c}_{32} )}^{2} + {( 0 - {c}_{33} )}^{2} … + {( 0 - {c}_{3 n} )}^{2} = {R}_{3}^{2} \\ {( {b}_{30} - {c}_{30} )}^{2} + {( 0 - {c}_{31} )}^{2} + {( {b}_{31} - {c}_{32} )}^{2} + {( 0 - {c}_{33} )}^{2} … + {( 0 - {c}_{3 n} )}^{2} = {R}_{3}^{2} \\ {( {b}_{40} - {c}_{30} )}^{2} + {( 0 - {c}_{31} )}^{2} + {( 0 - {c}_{32} )}^{2} + {( {b}_{41} - {c}_{33} )}^{2} … + {( 0 - {c}_{3 n} )}^{2} = {R}_{3}^{2} \\ … \\ {( {b}_{n + 1 , 0} - {c}_{30} )}^{2} + {( 0 - {c}_{31} )}^{2} + {( 0 - {c}_{32} )}^{2} + {( 0 - {c}_{33} )}^{2} … + {( {b}_{n + 1 , 1} - {c}_{3 n} )}^{2} = {R}_{3}^{2}\end{matrix} \}$$
Subtracts the j-th equation from the (j+1)-th equation:
$$[ \begin{matrix}2 ( {b}_{00} - {b}_{10} ) & 2 ( {b}_{01} - {b}_{11} ) & 0 & … & … & 0 \\ 2 ( {b}_{10} - {b}_{20} ) & 2 ( {b}_{11} - {b}_{21} ) & 0 & … & … & 0 \\ 2 ( {b}_{20} - {b}_{30} ) & 2 {b}_{21} & - 2 {b}_{31} & 0 & … & 0 \\ 2 ( {b}_{30} - {b}_{40} ) & 0 & 2 {b}_{31} & - 2 {b}_{41} & 0 … & 0 \\ & & … & & & \\ 2 ( {b}_{n 0} - {b}_{n + 1 , 0} ) & 0 & … & 0 & 2 {b}_{n 1} & - 2 {b}_{n + 1 , 1}\end{matrix} ] \\ [ \begin{matrix}{c}_{30} \\ {c}_{31} \\ {c}_{32} \\ {c}_{33} \\ … \\ {c}_{3 n}\end{matrix} ] = [ \begin{matrix}{b}_{00}^{2} + {b}_{01}^{2} - {b}_{10}^{2} - {b}_{11}^{2} \\ {b}_{10}^{2} + {b}_{11}^{2} - {b}_{20}^{2} - {b}_{21}^{2} \\ {b}_{20}^{2} + {b}_{21}^{2} - {b}_{30}^{2} - {b}_{31}^{2} \\ {b}_{30}^{2} + {b}_{31}^{2} - {b}_{40}^{2} - {b}_{41}^{2} \\ … \\ {b}_{n 0}^{2} + {b}_{n 1}^{2} - {b}_{n + 1 , 0}^{2} - {b}_{n + 1 , 1}^{2}\end{matrix} ]$$
The condition
$$[ 2 ( {b}_{00} - {b}_{10} ) \cdot 2 ( {b}_{11} - {b}_{21} ) - 2 ( {b}_{10} - {b}_{20} ) \cdot 2 ( {b}_{01} - {b}_{11} ) ] \cdot {\prod }_{t = 3}^{n + 1} ( - 2 {b}_{t 1} ) \neq 0$$
in (4.2) guarantees that the above system of equations has one and only one solution;
(4.4) The GC multicasts C₃, u₃ and all the identifiers of the leaving members to all the group members via open channel;
(4.5) The remnant members calculate their group keys:
Each remnant member compares its identifier with the identifiers of leaving members and computes the number of leaving members whose identifies less than its, and denoted by e; then each remnant members adjusts its identifier as ID=ID−e, where the value of e calculated by each member may not be the same, and e≧0 and e≦w; each remnant member calculates the group key:
Kᵢ=R₃²−∥C₃∥²=h(aᵢ₁,u₃)²+h(aᵢ₁,u₃)²−2h(aᵢ₀,u₃)c₁₀−2h(aᵢ₁,u₃)c_{3d}, where Kᵢ is the group key calculated by the user whose subscript is i, aᵢ₀,aᵢ₁ are the components of private information Aᵢ, d is the user's identifier, R₃ is the radius of the hypersphere, and
$${‖ {C}_{3} ‖}^{2} = {\sum }_{m = 0}^{n} {c}_{3 m}^{2} .$$

6. According to the secure group key management approach based upon N-dimensional hypersphere which is described in claim 1, characterized in that: If there is not member adding or removing operation happened, and the group key is not updated within a period of time, then the GC will start periodically update procedure to renew the group key to safeguard the secrecy of group communication; the GC should select another mapping parameter and re-map when the hypersphere can not be determined by the points; the GC calculates the central point of the hypersphere which is established by the points, and then publishes the central point and the mapping parameter; each user in the group calculates the mapping point by using its identifier, the central point and the mapping parameter, and then calculates its own group key.
